(19) United States
(12) Patent Application Publication
(10) Pub. No.: US 2022/0388926 A1
(43) Pub. Date: Dec. 8, 2022

(54) PREPARATIONS FOR ENHANCED BIOCONTROL

(71) Applicant: AREVO AB, UMEÅ (SE)

(72) Inventors: Torgny NÄSHOLM, UMEÅ (SE); Jonathan LOVE, UMEÅ (SE); Regina GRATZ, UEMÅ (SE)

(21) Appl. No.: 17/774,545

(22) PCT Filed: Nov. 5, 2020
(86) PCT No.: PCT/SE2020/051063

§ 371 Date: May 5, 2022

(30) Foreign Application Priority Data
Nov. 6, 2019 (SE) 1951269-8
Jul. 2, 2020 (SE) 2050828-9

(51) Int. Cl. C05G 1/00; C05G 3/40; C05F 11/08; C05B 15/00; A01C 1/06

(52) U.S. Cl. CPC C05G 1/00; C05G 3/40; C05F 11/08; C05B 15/00; A01C 1/06

(57) ABSTRACT

A composition, such as a liquid seed coating composition, comprises at least one macro nutrient and at least one microbe, which macro nutrient includes nitrogen in the form of a basic L-amino acid in association with phosphorus. The composition allows for an enhanced environment for planted seeds, e.g. by providing nitrogen in a form which is available for extended periods of time. Further, as compared to prior art products, the nitrogen is provided in a form which has been shown to be more beneficial to microbes present in soil surrounding the plant in terms of toxicity. The composition is advantageously a liquid slow release seed coating composition. Further, the invention includes a seed treated to extend the duration of the nitrogen effect without lethal effects to surrounding microbes, and a method of treating a seed to achieve the same objective.

### TECHNICAL FIELD

The present invention relates to the area of plant cultivation, particularly cultivation of plants utilizing biological agents such as microbes to directly or indirectly enhance their growth. Preparations according to the invention include compositions where a seed has been combined with microbes such as bacteria; as well as granules comprising bacteria together with binders, buffers and the like. Other preparations include compositions including microbes such as bacteria and are suitable for coating of seeds.

### BACKGROUND

The management of soils and growth substrates as living systems rather than an inert material with physicochemical properties suitable for plant growth is now widely accepted as an integral part of best practice for long-term value creation from farms, greenhouses and forests. The confluence of soil-borne microbes and microbial communities, the so called soil microbiome, together with plant-associated microbes, the plant microbiome, present a point of management intervention through the addition of beneficial microbes with potential for enhanced biocontrol as an alternative to chemical insecticides (e.g. Thiamethoxam, Clothianidin) and fungicides (e.g. Fludioxonil, Difenoconazole), stress protection including increased accessibility to otherwise unavailable nutrient reservoirs, or plant growth regulation leading to improved crop yield.

As such, there is a growing market for microbial inoculum products. Such products can be supplied directly to growth substrates such as soils, sand, peat etc., or they can be introduced to seeds or seedlings as these are deployed into various growth settings. The benefits and residual effectiveness of such products necessarily depend on the viability of the microbes and their capacity to survive and grow in the environment they are launched, in order to realise any potential benefits.

Nitrogen is a key element, ubiquitously needed by all life forms. Within all cropping systems, successful growth of plants, and thereby good harvests, depend on large inputs of nitrogen fertilizers to increase soil availability of nitrogen.

Various nitrogen fertilizers have been proposed. For example, WO 2017/200468 (Arevo AB) describes a fertilizer comprising at least one basic L-amino acid, such as arginine or lysine, wherein a substantial portion of the basic L-amino acid content is present as its monophosphate. The basic L-amino acid phosphate may be combined with a binder and/or provided with an outermost layer acting as a coating. The invention also relates to a method of enhancing the growth of a plant by making a basic L-amino acid phosphate available to the plant.

In natural ecosystems, nitrogen availability for plants is regulated by a complex network of organisms, chemical reactions and soil processes. In agricultural systems however, intentional addition of nitrogen through fertilization, has been shown to alter soil processes and in turn the plant-soil continuum in ways that are dependent on nitrogen form. This nitrogen-form dependent change includes a shift from oligotrophic types of bacteria, occasionally with capacities to fix atmospheric dinitrogen gas, to eutrophic types some of which are harmful to plants and hence may negatively affect crop production.

In other words, bacteria added in order to enhance the growth of a plant may be impacted in a negative way by the added fertilizer, and the result of the fertilization may be reduced growth rather than improved.

From the above, it is clear that there is an inherent conflict between intentional addition of nitrogen in the form of fertilizers, as well as unintentional addition of nitrogen via deposition of airborne nitrogen pollutants, and the viability and hence the predictability of plant growth promoting microbes. Thus, in any cropping system, finding robust, efficient co-applications of nitrogen and a beneficial microbe inoculum is at best difficult to anticipate and at worst renders the management tools incompatible. This means that fertilizing soils will inevitably restrict the function of products containing beneficial microbes. On a similar note, incorporation of beneficial microbes in seed coatings is not always fully compatible with incorporation of nitrogen into the same coating. Moreover, addition of specific strains of nitrogen-fixing bacteria that form symbioses with plants, for example Leguminosae's plants such as soy, peas or beans, is incompatible with addition of nitrogen to enhance growth of such plants at early stages of development, before a nitrogen-fixing symbiosis has been established.

The effects discussed above have been discussed and described in several research reviews, see e.g. Zahran in Rhizobium-Legume Symbiosis and Nitrogen Fixation under Severe Conditions and in an Arid Climate (Microbiology and Molecular Biology Reviews, December 1999, p. 968-989).

Additional technologies for making the area of plant fertilizers environmentally friendly are constantly presented. For example, WO 2017/222464 (SweTree Nutrition AB) describes a fertilizer proposed to reduce the resources required in the fertilization of slowly growing plants, as repeated supply of nutrients as well as leakage of nitrogen may be avoided. More specifically, the proposed fertilizer composition comprises zeolites, into the pores of which at least one basic L-amino acid has been adsorbed.

Carlos Eduardo Flores-Tinoco et al (in “Co-catabolism of arginine and succinate drives symbiotic nitrogen fixation” available at https://www.biorxiv.org/content/10.1101/741314v1?versioned=true on Aug. 21, 2019:) is an article related to the symbiosis between bacteria and crop plants and specifically to the metabolic blueprint for symbiotic nitrogen fixation. A metabolic network based on co-catabolism of plant-provided arginine and succinate driving the energy-demanding process of symbiotic nitrogen fixation in endosymbiotic rhizobia is described as CATCH-N. In this article, it is concluded that the co-feeding of arginine and succinate stimulates nitrogenase activity.

Zhang et al (in Frontiers in Plant Science, published 22 Oct. 2019: “Organic or Inorganic Nitrogen and Rhizobia Inoculation Provide Synergistic Growth Response of a Leguminous Forb and Tree”) presents a study of how organic and inorganic nitrogen affects plant growth and performance of symbiotic, N₂-fixing rhizobia. Zhang et al concludes that the studied species responded well to organic or inorganic N forms (or various forms of inorganic N), suggesting that the nodulation response may depend on plant species, and that N supply and nodulation can be synergistic.

US 2013/0255338 (Agrinos) describes compositions that enhance crop production, increase plant defensive processes and/or decrease the level of plant pathogens. The compositions comprise a microbial composition and liquid fertilizer, preferably a liquid fertilizer that contains at least soluble nitrogen. In one embodiment, the compositions comprise one or more lactic acid producing bacteria, one or more nitrogen fixing bacteria, and liquid fertilizer comprising soluble nitrogen. In the preferred embodiment, the described composition comprises a liquid fertilizer and HYTa, which is a consortium of microorganisms including Lactobacteria, nitrogen fixing bacteria, microorganisms that solubilize/mineralize sources of potassium, phosphorous and organic carbon, Bacillus subtilis, Bacillus thuringiensis strains HD-1 and HD-73, and Trichoderma harzianum. Alternatively, HYTd is used, which is described as comprising 12 wt % L-amino acids (Aspartic acid, Glutamic acid Serine, Histidine, Glycine, Threonine, Alanine, Proline, Arginine, Valine, Methionine, Isoleucine, Tryptophan, Phenylalanine, Lysine and threonine) and 5 wt % glucosamine and chitosan. HYTd also preferable contains one or more or all of soluble minerals (P, Ca, Mg, Zn, Fe and Cu), enzymes and lactic acid from the chitin digestion process as well as other polysaccharides.

Despite the above, there is a need in the area of biocontrol to identify means and methods that may alleviate the negative impact that nitrogen-containing fertilizers may have on the viability of growth-enhancing bacteria.

### BRIEF DESCRIPTION OF THE INVENTION

The present invention relates to the combination of at least one seed with at least one microbe, which composition further comprises one or more macro nutrients, wherein one such macro nutrient comprises nitrogen in the form of a basic L-amino acid. Specifically, the invention relates to compositions suitable for use as liquid seed coating compositions, such as slow release compositions.

Thus, more specifically, in the first aspect, the invention includes a composition comprising at least one macro nutrient and at least one microbe, which macro nutrient includes nitrogen in the form of a basic L-amino acid in association with phosphorus.

In another aspect, the invention relates to a seed treated with at least one selected microbe, a macro nutrient comprising nitrogen in the form of a basic L-amino acid and phosphorus.

In a further aspect, the invention relates to a method for treating a seed with a liquid composition, which method comprises the steps of
a) providing at least one microbe;
b) providing a macro nutrient including nitrogen in the form of a basic L-amino acid;
c) applying said at least one microbe and the macro nutrient to at least one seed.

In another aspect, the invention relates to a method of manufacturing a growth additive, such as a seed coating composition, which method comprises the steps of
a) providing an inoculum of a microbe which enhances the growth of a plant when used as a growth additive;
b) providing a macro nutrient comprising nitrogen and optionally additional nutrient(s); and
c) combining the inoculum and the macro nutrient with a binder;
   wherein the macro nutrient comprises nitrogen in the form of a basic L-amino acid.

In yet another aspect, the invention relates to a method of plant cultivation, where a composition according to the first aspect; or a growth additive according to the second aspect together with a seed; are added to the site of plantation in an amount adapted to the specific growth need of said seed.

### BRIEF DESCRIPTION OF THE DRAWINGS

FIG. 1 shows agar plates on which the growth response of B. megaterium (left) and B. japonicum (right) to L-arginine phosphate was tested.

FIG. 2 shows the growth response of B. megaterium (left) and B. japonicum (right) to increasing concentrations of arGrow® Complete, containing only L-arginine as nitrogen source.

FIG. 3 shows the growth response of B. megaterium (left) and B. japonicum (right) to increasing concentrations of RIKA-S, containing nitrate and ammonium as nitrogen sources.

FIG. 4 shows the growth response of B. megaterium (left) and B. japonicum (right) to different nitrogen sources (L-arginine phosphate “4.1”, arGrow® Complete “4.2” and RIKA-S “4.3”) partially supplemented with zeolites “+”.

FIG. 5 shows the growth response of B. megaterium (left) and B. japonicum (right) to different nitrogen sources (L-arginine phosphate “5.1”, arGrow® Complete “5.2” and RIKA-S “5.3”), partially supplemented with 7.4 mM succinic acid “+”.

FIG. 6 shows the shoot dry weight of soybeans 105 days after planting which were fertilized with different nitrogen sources (arGrow® Complete and RIKA-S) at planting.

FIG. 7 shows the number (7.1) and dry weight (7.2) of soybean root nodules. Plants were grown for 90 days and fertilized with different nitrogen sources (arGrow® Complete and RIKA-S) at the vegetative stage.

FIG. 8 shows the number (8.1) and dry weight (8.2) of soybean pods. Plants were grown for 105 days and fertilized with different nitrogen sources (arGrow® Complete and RIKA-S) at planting.

FIG. 9 shows the percentage of nodulated field bean roots of sand-grown plants after 20 days (9.1). The color (either pink or white) of respective nodules from plants grown in soil for seeding for 57 days is displayed (9.2). Plants were fertilized with different nitrogen sources (arGrow® Complete and RIKA-S) at planting.

FIG. 10 shows the germination rate of soybean seeds that were partially coated with 10 mg L-arginine phosphate/seed, either after 6 days on filter paper (10.1) or after 10 days in sand (10.2).

### DETAILED DESCRIPTION OF THE INVENTION

The current invention relates to technology aimed at alleviating the incompatibility of nitrogen-containing fertilizers and microbes used to improve the growth conditions of a plant. The present inventors have surprisingly found that certain forms of nitrogen and their derivatives do not negatively affect beneficial microbes. In addition, these forms of nitrogen appear to also stimulate the growth of such microbes within a wide range of concentrations or addition rates.

Thus, in a first aspect, the present invention relates to a composition comprising at least one macro nutrient and at least one microbe, which macro nutrient includes nitrogen in the form of a basic L-amino acid in association with phosphorus. The microbe is advantageously a selected microbe, i.e. one or more microbes which have been defined as advantageous for the growth of a specific plant. Suitable microbes will be discussed in more detail below.

The basic L-amino acid may be associated with phosphorus via strong intermolecular interactions, such as covalent bonding or hydrogen bonding.

Some general bond strengths are provided for illustrative purposes below. In some embodiments, the most prominent molecular interactions are selected from the group consisting of hydrogen bonding, which may be defined as a polar bond H-dipole charge in the range of 10-40 kJ/mol; and ion-dipole interaction, which may be defined by ion charge-dipole charges in the range of 40-600 kJ/mol. In some embodiments, the intermolecular interactions are selected from the group consisting of generally weaker forces such as dipole-dipole interaction, which may be defined by dipole charges in the range of 5-25 kJ/mol; ion-induced dipole interaction, which may be defined by ion charge-polarizable e-clouds in in the range of 3-15 kJ/mol; dipole-induced dipole interaction, which may be defined by dipole charge-polarizable e-clouds in in the range of 2-10 kJ/mol; and dispersion i.e. London interaction, which may be defined by polarizable e-clouds in in the range of 0.05-40 kJ/mol.

Thus, the invention relates to embodiments where the basic L-amino acid is associated with phosphorus by one or more of the interactions above, for example where the association is defined by about 50%, about 75%, about 80%, about 90% or about 95% being one or more of the herein exemplified molecular interactions. Illustrative ranges would be that 50-60%, 50-75%, 50-95% or 50-98% of the associations are one or more of the interactions above. In some embodiments, the association is defined by at least 50%, at least 80%, at least 90% or at least 95% of one or more of the herein exemplified molecular interactions.

As the skilled person will appreciate, the kind of interaction will be affected by pH and other conditions surrounding the composition of the invention.

Thus, in the present context, the phrase “associated with” is understood as different from the case where basic L-amino acid and phosphorus have been added to a composition together with a number of other components, in which case other components will dilute their combined effect. Specifically, from a functional point of view, the term “associated with” is understood herein as a connection which prevents for most of the basic L-amino acid degradation by enzymes, such as arginase, before being available as fertilizer to a growing plant. In some embodiments, at least about 50% of the basic L-amino acid present in the composition is associated with phosphorus as defined herein. In some embodiments, at least about 60%, at least about 75%, at least about 80%, at least about 90%, or at least about 95% or substantially all, such as more than about 99%, of the basic L-amino acid present in the composition is associated with phosphorus as defined herein. Illustrative ranges are that 50-60%, 50-70%, 60-70%, 60-80%, 60-75%, 70-80%, 70-90%, 70-85%, 80-90%, 80-95%, 85-90%, 85-95%, 90-95%, 90-98%, 95-98%, 95-98% or 98-99% of the basic L-amino acid present in the composition is associated with phosphorus as defined herein.

Thus, the present invention utilises the association with phosphorus to prolong the duration of the positive effects of the basic L-amino acid to the growing plant originating from the seed. Hence, the composition according to the invention provides for a long term effect of the nitrogen provided in the form of a basic L-amino acid, and may therefore be regarded as a slow release composition. In this context, the positive effect refers to the ability of a basic L-amino acid to enhance the growth of a plant without lethal effects, i.e. toxicity, to the microbes are also known to enhance the plant growth.

The composition of the invention may be a fertilizer, such as a liquid fertilizer composition. Alternatively, the composition may be formulated as solid composition, such as a solid fertilizer, which alternatively may be combined with water to provide a liquid composition. The liquid composition according to the invention may be a seed coating composition, which is suitable for applying to a seed by any desired means such as by coating, such as spray coating, or by soaking a seed therewith.

Thus, if the basic L-amino acid is arginine, the basic L-amino acid associated with phosphorus may be arginine phosphate, such as arginine monophosphate and/or arginine polyphosphate. Similarly, if the basic amino acid is lysine, the basic L-amino acid associated with phosphorus may be lysine phosphate, such as lysine monophosphate and/or lysine polyphosphate

However, as the skilled person will appreciate, there are other electrostatic interactions that can associate the basic L-amino acid with phosphorus. For example, with covalent coupling, the basic L-amino acid associated with phosphorus may be phosphoarginine or phospholysine.

In the present composition, the microbe may be selected among any nitrogen-fixing bacteria, such as mutualistic (symbiotic) bacteria, including Rhizobium associated with leguminous plants; Frankia associated with certain dicotyledonous species, and certain Azospirillum species, associated with cereal grasses; or free-living (non-symbiotic) bacteria, including the cyanobacteria Anabaena and Nostoc and genera such as Azotobacter, Beijerinckia, and Clostridium. For example, the microbe may belong to the genus Bacillus.

As discussed above, the composition of the invention may be a solid or liquid composition, wherein the microbe(s) may be present in any desired form of their respective development stage. Thus, the composition of the invention may include e.g. dormant spores, or living bacteria, of one or more selected species. Advantageously, the composition comprises bacteria, for example in the spore stage of development, in an inoculum, preferably within a carrier such as a polymer or other supporting structure. Such structures are well known in the area of biocontrol and include specific examples, such as alginate. As the skilled person will appreciate, for example, dry forms of microbes may be preferred if a dry composition is prepared and provided for subsequent dissolution in water before use.

The basic L-amino acid present in the composition according to the invention may be any basic L-amino acid, such as arginine or lysine; and is advantageously arginine. The arginine may have been derivatised or reacted with another macro nutrient. Thus, the composition according to the invention may comprise a phosphate of arginine, such as arginine polyphosphate or arginine monophosphate.

Though arginine is known to be a growth-enhancing macro nutrient, until now it has not been known as an agent capable of protecting growth-enhancing microbes from the toxicity commonly associated with nitrogen-containing additives.

Additional advantages appear to be provided from combining the basic L-amino acid, such as the arginine or arginine monophosphate, with a buffer such as a microporous aluminosilicate mineral. Thus, the present composition may include organic nitrogen-containing structures, such as arginine or arginine monophosphate, combined with a zeolite. Zeolites are available as native materials or as synthetic structures, and the present invention is not limited to any specific form of zeolite. Advantageously, the composition according to the invention includes zeolites capable of being loaded with arginine monophosphate, e.g. as described in the above-discussed WO 2017/222464.

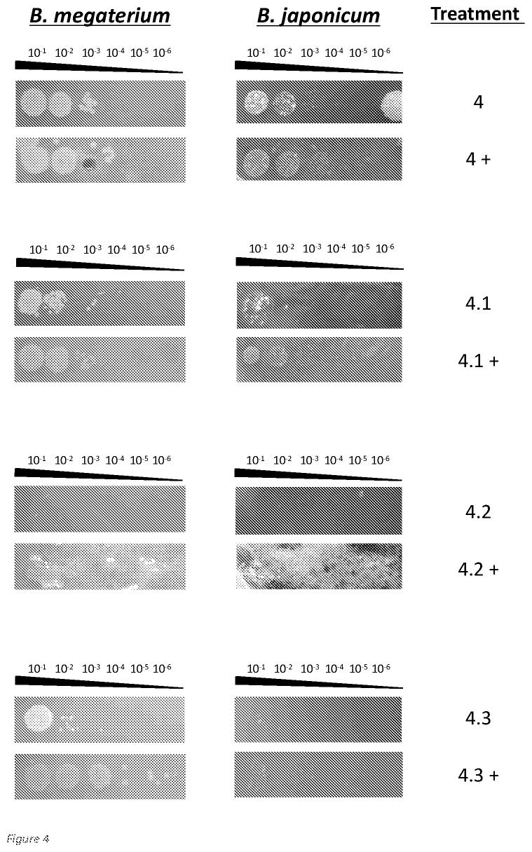

In a broader aspect, the invention also embraces the use of zeolites combined with nitrogen which is not present in the form of basic L-amino acids, as supported by FIG. 4. Thus, this effect may be utilized in compositions and granules which comprise nitrogen in any chemical structure, such as ammonium nitrate or in mixtures of basic L-amino acids with other forms of nitrogen.

Another aspect of the invention is a seed treated with at least one selected microbe, a macro nutrient comprising nitrogen in the form of a basic L-amino acid and phosphorus. The seed according to the invention may have been coated or otherwise treated with a composition as described in detail above, and/or prepared as described below.

Alternatively, the seed according to the invention may comprise at least one layer of said at least one microbe and at least one layer of said nitrogen in the form of a basic L-amino acid in association with phosphorus. All details and examples provided above in relation to the chemistry and advantageous effects of such association also applies to this aspect of the invention.

The present seed may for example have been soaked, sprayed or treated with an aqueous solution of said at least one microbe in any suitable way. The nitrogen in the form of a basic L-amino acid associated with phosphorus may be applied as a separate layer, for example in an aqueous solution which is sprayed or applied in any other suitable way to the treated seed.

As discussed above, the basic L-amino acid is advantageously associated with phosphorus via electrostatic interaction. All details provided elsewhere in the present application regarding the nature of such association are also applicable to this aspect of the invention.

Thus, the basic L-amino acid associated with phosphorus may be arginine phosphate and/or phosphoarginine. Alternatively, the basic L-amino acid associated with phosphorus may be lysine phosphate and/or phospholysine.

Another aspect of the invention is a method for treating a seed with a liquid composition, which method comprises the steps of
a) providing at least one microbe, such as a selected microbe;
b) providing a macro nutrient including nitrogen in the form of a basic L-amino acid;
c) applying said at least one microbe and the macro nutrient to at least one seed.

Step c) may include combining said at least one microbe and the macro nutrient with a binder to provide a liquid composition for application to said at least one seed.

In an advantageous embodiment, the step of combining the microbe(s) with the binder comprises granulation.

The microbe may be a nitrogen-fixing bacterium, as discussed above, and the basic L-amino acid may advantageously be arginine or lysine. As the skilled person will appreciated, the microbe(s) are selected based on their properties as growth enhancers to the plant originating from the treated seed. All details provided elsewhere in this application with regard to the microbe(s) are equally applicable to this aspect of the invention.

The macro nutrient of step b may advantageously further comprise phosphorus, such as phosphorus associated with a basic L-amino acid via electrostatic interaction. All details and examples provided above in relation to the chemistry and advantageous effects of such association also applies to this aspect of the invention.

The present method may comprise a step of treating the seed with phosphorus, separately or at the same time as the macro nutrient.

A method according to the invention may be a cyclic process, including at least one cycle of applying a macro nutrient, e.g. in an aqueous solution; and applying phosphorus, e.g. in an aqueous solution; and an optional step of drying the seed in between said applications.

The microbe may be applied to the seed before the macro nutrient and the phosphorus, such as by soaking the seed with an aqueous solution comprising the microbe. Alternatively, the macro nutrient and the phosphorus may be mixed before the application thereof to a seed, for example in an aqueous solution.

In another aspect, the invention relates to a method of manufacturing a growth additive, such as the above-discussed composition, which method comprises the steps of
a) providing an inoculum of a microbe which enhances the growth of a plant when used as a growth additive;
b) providing a macro nutrient comprising nitrogen and optionally additional macro nutrient(s); and
c) combining the inoculum and the macro nutrient with a binder;
   wherein the macro nutrient comprises nitrogen in the form of a basic L-amino acid.

The present growth additive may be combined with one or more seeds during its manufacture, or, alternatively, at a later point in time such as at plantation. As the skilled person will appreciate, all details provided elsewhere in this application related to the seed are equally applicable to this aspect, such as layering, order of addition of components etc.

Advantageously, the step of combining the inoculum with the binder may also comprise a granulation, in accordance with well-known methods.

The microbe provided in the present method is selected for its advantageous growth enhancing properties, and may be any bacteria, such as the above-discussed nitrogen-fixing bacteria. Specifically, the microbe may belong to the genera Rhizobium or Bacillus.

The basic L-amino acid provided in the present method may be any one of the above-discussed forms, such as arginine, arginine phosphate, e.g. arginine monophosphate.

Monophosphates of basic L-amino acids are easily prepared by the skilled person following well known methods. Such amino acid monophosphate(s) may be crystalline i.e. salts. Alternatively, covalent coupling may used to prepare amino acid monophosphate(s). Further, all details provided elsewhere in the present application, such as in relation to the first aspect, with regard to the association of a basic L-amino acid with phosphorus are equally applicable to this aspect of the invention.

Binders suitable for the method according to the invention are well known in this area, and the skilled person can easily select an appropriate material. Thus, the binder may e.g. be selected from the group consisting of polymers, such as synthetic polymers or natural polymers, such as sugars or carbohydrates; salts; and minerals.

Methods of preparing phosphates of basic L-amino acids may e.g. be as described in WO2017/200468 and WO2017/200467.

Further, the basic L-amino acid provided in the present method may be combined with a microporous aluminosilicate mineral, such as a zeolite, as discussed above in relation to the first aspect of the invention.

In a third aspect, the invention relates to a method of plant cultivation, where a composition according to the first aspect; or a growth additive according to the second aspect together with a seed; are added to the site of plantation in an amount adapted to the specific growth need of said seed. All details discussed above in relation to the first and the second aspect of the invention apply to this aspect as well.

The effect of such a method is an improved overall growth of the plant due to the improved biocontrol thereof, where growth-stimulating nitrogen will be provided in a form that will not disturb the beneficial effects of the microbes. Such a method also is an environmentally friendly way of improving growth, since nitrogen is provided in a form with minimal leakage out from the growth setting and chemical preparations may be avoided.

### DETAILED DESCRIPTION OF THE DRAWINGS

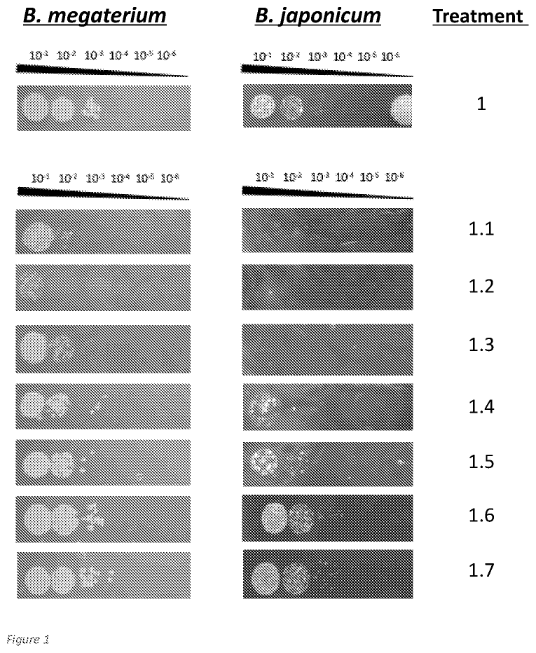

FIG. 1 illustrates the influence of L-arginine phosphate as sole nitrogen source on the survival of two different bacteria. More specifically, different dilutions of Bacillus megaterium (left column) and Bacillus japonicum (right column), ranging from OD₆₀₀ of 10⁻¹ to 10⁻⁶, were spotted onto LB agar. The LB agar contained different concentrations of supplemented arginine phosphate, hereby referred to as “treatment 1”. The different supplemented N concentrations are listed in the following table:

| | | Concentration | |
|---|---|---|---|
| | | of | |
| | | supplemented | Form of |
| Treatment | N supplement | N | supplemented N |
| 1 | none | none | none |
| 1.1 | L-arginine phosphate | 700 mmol N/l | arginine monophosphate |
| 1.2 | L-arginine phosphate | 600 mmol N/l | arginine monophosphate |
| 1.3 | L-arginine phosphate | 500 mmol N/l | arginine monophosphate |
| 1.4 | L-arginine phosphate | 400 mmol N/l | arginine monophosphate |
| 1.5 | L-arginine phosphate | 300 mmol N/l | arginine monophosphate |
| 1.6 | L-arginine phosphate | 200 mmol N/l | arginine monophosphate |
| 1.7 | L-arginine phosphate | 100 mmol N/l | arginine monophosphate |

Growth of bacteria was analyzed after 24 hours (B. megaterium) and 3 days (B. japonicum) respectively, by observing the presence of round-shaped colonies.

Treatment 1 served as control, as no additional N supplement was added into the LB agar. Growth of bacteria was observed in the dilutions of 10⁻¹ through 10⁻³ for B. megaterium and 10⁻¹ through 10⁻⁴ for B. japonicum, observable by the presence of round, white colonies. The prominent white sphere close to the 10⁻⁶ mark in the B. japonicum spotting is a contamination, clearly visible by the different shape and structure of the microorganism. For the results shown in FIGS. 1-4, this control is identical, as the experiments were performed in parallel.

The highest concentration tested, 700 mmol N/l of arginine phosphate (treatment 1.1), led to the growth of B. megaterium up to a dilution of 10⁻² whereas B. japonicum did not show growth at all. In treatment 1.2 (600 mmol N/l of arginine phosphate) B. megaterium grew in a dilution of 10⁻¹ only, no growth could be observed for B. japonicum. Both bacterial strains showed growth at treatment 1.3 (500 mmol N/l of arginine phosphate). B. megaterium displayed colony growth up to a dilution of 10⁻³, whereas B. japonicum showed a few colonies at 10⁻¹ only. Bacterial growth was overall stronger in treatment 1.4 (400 mmol N/l of arginine phosphate) in which B. megaterium displayed colony growth up to a dilution of 10⁻³ and B. japonicum up to 10⁻². A similar observation occurred in treatment 1.5 (300 mmol N/l of arginine phosphate), in which B. megaterium displayed colony growth up to a dilution of 10⁻³ and B. japonicum up to 10⁻². Treatment 1.6 (200 mmol N/l of arginine phosphate) attenuated bacterial growth for both strains at 10⁻⁴ dilutions. Reducing the N concentration in treatment 1.7 (100 mmol N/l of arginine phosphate) led to growth of both strains until a dilution of 10⁻⁴.

In summary, in accordance with the findings of the present invention, arginine phosphate confers no lethal toxicity to B. megaterium to the extent of the maximal tested concentration of 700 mmol N/l. Concordantly, lethal effects are not visible during cultivation of B. japonicum upon a concentration of 500 mmol N/l arginine phosphate.

FIG. 1 shows the results from spotting different dilutions of B. megaterium (left column) and B. japonicum (right column), ranging from OD₆₀₀ of 10⁻¹ to 10⁻⁶ onto LB agar. The LB agar contained different concentrations of supplemented arGrow® Complete (available from Arevo AB), hereby referred to as “treatment 2”. The different supplemented N concentrations are listed in the following table:

| | | Concentration | |
|---|---|---|---|
| | | of | |
| | | supplemented | Form of |
| Treatment | N supplement | N | supplemented N |
| 2 | none | none | none |
| 2.1 | arGrow ® Complete | 700 mmol N/l | arginine free base |
| 2.2 | arGrow ® Complete | 600 mmol N/l | arginine free base |
| 2.3 | arGrow ® Complete | 500 mmol N/l | arginine free base |
| 2.4 | arGrow ® Complete | 400 mmol N/l | arginine free base |
| 2.5 | arGrow ® Complete | 300 mmol N/l | arginine free base |
| 2.6 | arGrow ® Complete | 200 mmol N/l | arginine free base |
| 2.7 | arGrow ® Complete | 100 mmol N/l | arginine free base |

Growth of bacteria was analyzed after 24 hours (B. megaterium) and 3 days (B. japonicum) respectively, by observing the presence of round-shaped colonies.

Treatment 2 served as control, as no additional N supplement was added into the LB agar. Growth of bacteria was observed in the dilutions of 10⁻¹ through 10⁻³ for B. megaterium and 10⁻¹ through 10⁻⁴ for B. japonicum observable by the presence of round, white colonies. The prominent white sphere close to the 10⁻⁶ mark in the B. japonicum spotting is a contamination, clearly visible by the different shape and structure of the microorganism. For the results shown in FIGS. 1-4, this control is identical, as the experiments were performed in parallel.

The tested N concentrations ranging from 700 mmol N/l (treatment 2.1) to 400 mmol N/l (treatment 2.4) of arGrow® Complete prevented bacterial growth in case of both strains. Bacterial growth could be observed in treatment 2.5 (300 mmol N/l of arGrow® Complete), in which B. megaterium displayed colony growth up to a dilution of 10⁻² and B. japonicum up to 10⁻¹. The prominent white colony partially overlapping with the true B. japonicum colonies present at a dilution of 10⁻¹ is a result of a contamination. Treatment 2.6 (200 mmol N/l of arGrow® Complete) terminated bacterial growth for B. megaterium at the 10⁻⁵ dilution and at 10⁻³ for B. japonicum. Reducing the N concentration in treatment 2.7 (100 mmol N/l of arGrow® Complete) led to growth of both strains until a dilution of 10⁻³ for both strains.

In summary, arGrow® Complete confers no lethal toxicity to B. megaterium and B. japonicum up to a concentration of 300 mmol N/l.

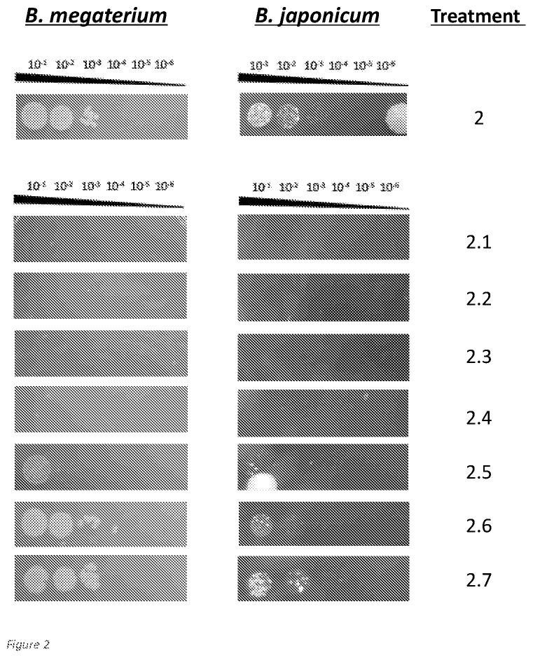

FIG. 2 shows the results from spotting different dilutions of B. megaterium (left column) and B. japonicum (right column), ranging from OD₆₀₀ of 10⁻¹ to 10⁻⁶ onto LB agar. The LB agar contained different concentrations of supplemented RIKA-S, hereby referred to as “treatment 3”. The different supplemented N concentrations are listed in the following table:

| | | Concentration of | Form of |
|---|---|---|---|
| Treatment | N supplement | supplemented N | supplemented N |
| 3 | none | none | none |
| 3.1 | RIKA-S | 700 mmol N/l | ammonium nitrate |
| 3.2 | RIKA-S | 600 mmol N/l | ammonium nitrate |
| 3.3 | RIKA-S | 500 mmol N/l | ammonium nitrate |
| 3.4 | RIKA-S | 400 mmol N/l | ammonium nitrate |
| 3.5 | RIKA-S | 300 mmol N/l | ammonium nitrate |
| 3.6 | RIKA-S | 200 mmol N/l | ammonium nitrate |
| 3.7 | RIKA-S | 100 mmol N/l | ammonium nitrate |

Growth of bacteria was analyzed after 24 hours (B. megaterium) and 3 days (B. japonicum) respectively, by observing the presence of round-shaped colonies.

Treatment 3 served as control, as no additional N supplement was added into the LB agar. Growth of bacteria was observed in the dilutions of 10⁻¹ through 10⁻³ for B. megaterium and 10⁻¹ through 10⁻⁴ for B. japonicum observable by the presence of round, white colonies. The prominent white sphere close to the 10⁻⁶ mark in the B. japonicum spotting is a contamination, clearly visible by the different shape and structure of the microorganism. For the results shown in FIGS. 1-4, this control is identical, as the experiments were performed in parallel.

The tested N concentrations ranging from 700 mmol N/l (treatment 3.1) to 200 mmol N/l (treatment 3.6) of RIKA-S conferred lethal toxicity to both strains and hence inhibited bacterial growth. Visible dots in treatment 3.3 do not result from bacterial growth but are caused by air inclusions in the LB agar. Bacterial growth could only be observed in treatment 3.7 (100 mmol N/l of RIKA-S), in which B. megaterium displayed colony growth up to a dilution of 10⁻³ and B. japonicum up to 10⁻².

In summary, the representative commercial fertilizer, RIKA-S, containing ammonium and nitrate as nitrogen sources, confers lethal toxicity to B. megaterium and B. japonicum starting from a concentration already above 100 mmol N/l and hence displays to be the most lethal N supplement tested with respect to B. megaterium and B. japonicum survival.

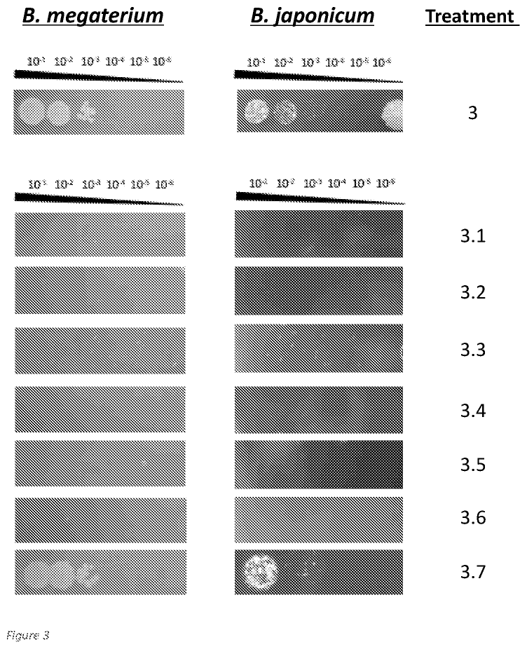

FIG. 3 illustrates the results from spotting different dilutions of B. megaterium (left column) and B. japonicum (right column), ranging from OD₆₀₀ of 10⁻¹ to 10⁻⁶ onto LB agar. The LB agar contained different concentrations of a variety of supplemented N forms as well as 200 mg of non-loaded zeolites, which were only partially added (marked by a “+”). The different supplements are listed in the following table (“treatment 4”):

| | | Concentration | | Addition of |
|---|---|---|---|---|
| | | of | | 200 mg |
| | N | supplemented | Form of | non-loaded |
| Treatment | supplement | N | supplemented N | zeolites |
| 4 | none | none | none | no |
| 4+ | none | none | none | yes |
| 4.1 | L-arginine | 400 mmol N/l | arginine | no |
| | phosphate | | monophosphate | |
| 4.1+ | L-arginine | 400 mmol N/l | arginine | yes |
| | phosphate | | monophosphate | |
| 4.2 | arGrow ® | 400 mmol N/l | arginine free base | no |
| | Complete | | | |
| 4.2+ | arGrow ® | 400 mmol N/l | arginine free base | yes |
| | Complete | | | |
| 4.3 | RIKA-S | 100 mmol N/l | ammonium | no |
| | | | nitrate | |
| 4.3+ | RIKA-S | 100 mmol N/l | ammonium | yes |
| | | | nitrate | |

Growth of bacteria was analyzed after 24 hours (B. megaterium) and 3 days (B. japonicum) respectively, by observing the presence of round-shaped colonies.

Treatments 4 and 4+ served as controls, as no additional N supplement was added into the LB agar. Treatment 4+ contained 200 mg of zeolites as a supplement in the LB agar in addition. In treatment 4, growth of bacteria was observed in the dilutions of 10⁻¹ through 10⁻³ for B. megaterium and 10⁻¹ through 10⁻⁴ for B. japonicum, observable by the presence of round, white colonies. The prominent white sphere close to the 10⁻⁶ mark in the B. japonicum spotting is a contamination, clearly visible by the different shape and structure of the microorganism. For the results shown in FIGS. 1-4, this control is identical, as the experiments were performed in parallel. Upon the addition of 200 mg zeolites (treatment 4+), both strains showed a similar growth response, B. megaterium grew until a dilution of 10⁻³ and B. japonicum up to a dilution of 10⁻⁴.

Adding 400 mmol N/l of L-arginine phosphate into the LB medium resulted in growth of B. megaterium until a dilution of 10⁻³ and B. japonicum until a dilution of 10⁻² (treatment 4.1). The supplementation of 200 mg zeolites (treatment 4.1+) increased the tolerance of both strains against L-arginine phosphate and promoted bacterial growth up until a dilution of 10⁻³ and 10⁻⁴ respectively. No growth of either bacterial strain was detectable when spotted on 400 mmol N/l of arGrow® Complete (treatment 4.2). A similar, positive effect of zeolites was visible in LB media, which was supplemented with 400 mmol N/l of arGrow® Complete (treatment 4.2+). B. megaterium grew until a dilution of 10⁻² and B. japonicum until a dilution of 10⁻¹ when zeolites were added. Both bacteria grew on LB agar, supplemented with 100 mmol N/l RIKA-S, up to a dilution of 10⁻³ (B. megaterium) and 10⁻¹ (B. japonicum) (treatment 4.3). The positive effect of 200 mg zeolites on bacterial growth counteracting the toxic effect of RIKA-S was visible in treatment 4.3+. B. megaterium showed bacterial growth until a dilution of 10⁻⁵ and B. japonicum until a dilution of 10⁻².

In summary it was observed that the overall lethality of bacteria due to high N concentrations was attenuated when zeolites were present in the LB agar.

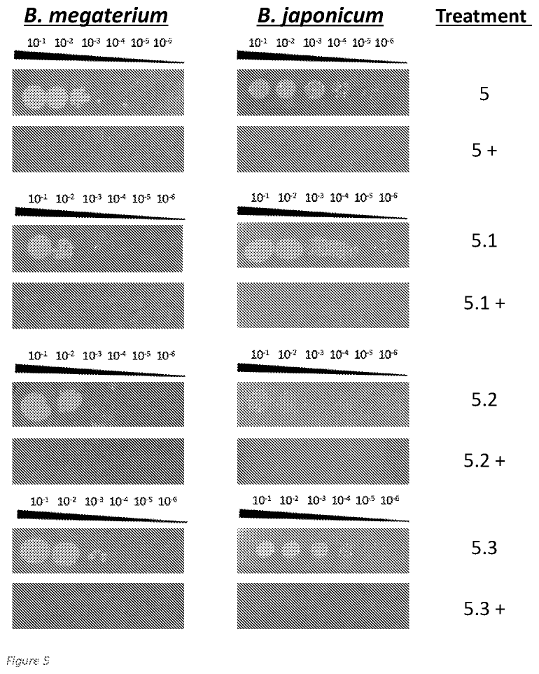

FIG. 5 illustrates the results from spotting different dilutions of B. megaterium (left column) and B. japonicum (right column), ranging from OD₆₀₀ of 10⁻¹ to 10⁻⁶ onto LB agar. The LB agar contained different concentrations of a variety of supplemented N forms as well as 7.4 mM succinic acid, which was only partially added (“+”). The different supplements are listed in the following table (“treatment 5”):

| | | Concentration | | Addition |
|---|---|---|---|---|
| | | of | Form of | of 7.4 mM |
| | N | supplemented | supplemented | succinic |
| Treatment | supplement | N | N | acid |
| 5 | none | none | none | no |
| 5+ | none | none | none | yes |
| 5.1 | L-arginine | 100 mmol N/l | L-arginine | no |
| | phosphate | | monophosphate | |
| 5.1+ | L-arginine | 100 mmol N/l | L-arginine | yes |
| | phosphate | | monophosphate | |
| 5.2 | arGrow ® | 100 mmol N/l | L-arginine free | no |
| | Complete | | base | |
| 5.2+ | arGrow ® | 100 mmol N/l | L-arginine free | yes |
| | Complete | | base | |
| 5.3 | RIKA-S | 50 mmol N/l | ammonium | no |
| | | | nitrate | |
| 5.3+ | RIKA-S | 50 mmol N/l | ammonium | yes |
| | | | nitrate | |

Growth of bacteria was analyzed after 24 hours (B. megaterium) and 4 days (B. japonicum) respectively, by observing the presence of round-shaped colonies.

Treatments 5 and 5+ served as controls, as no additional N supplement was added into the LB agar. Treatment 5+ contained 7.4 mM sterile filtered succinic acid as a supplement in the LB agar. In treatment 5, growth of bacteria was observed in the dilutions of 10⁻¹ through 10⁻⁴ for B. megaterium and 10⁻¹ through 10⁻⁵ for B. japonicum, observable by the presence of round, white colonies. Upon the addition of succinic acid (treatment 5+), both strains were impaired in growth.

Adding 100 mmol N/l of L-arginine phosphate into the LB medium (treatment 5.1) resulted in growth of B. megaterium until a dilution of 10⁻² and B. japonicum until a dilution of 10⁻⁵ (treatment 5.1). The supplementation of succinic acid (treatment 5.1+) prevented growth of both strains.

Adding 100 mmol N/l of arGrow® Complete into the LB medium (treatment 5.2) resulted in growth of B. megaterium until a dilution of 10⁻³ and B. japonicum until a dilution of 10⁻². The supplementation of succinic acid (treatment 5.2+) prevented growth of both strains. Addition of 50 mmol N/l of RIKA-S into the LB medium (treatment 5.3) resulted in growth of B. megaterium until a dilution of 10⁻³ and B. japonicum until a dilution of 10⁻⁵ (treatment 5.3). The supplementation of succinic acid (treatment 5.3+) prevented growth of both strains.

In summary it was observed that the addition of succinic acid to bacterial growth media impairs bacterial growth and does not enhance bacterial viability.

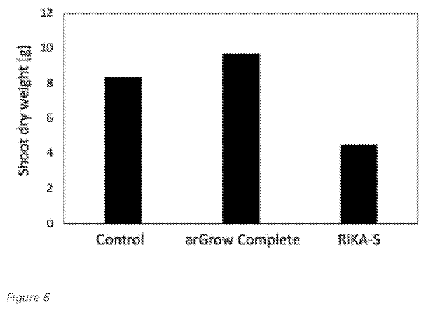

FIG. 6 illustrates the shoot dry weight of soybeans that were grown in a low N potting substrate, “Såjord” (Hasselfors Garden), for 105 days in greenhouse conditions. All seeds have been inoculated with rhizobia. The presented control plants were not fertilized. Other plants were either fertilized with 30 kg N/ha arGrow® Complete or RIKA-S, as indicated. Treatment with arGrow® Complete at planting resulted in an increased shoot biomass production of the soybean compared to the non-treated control. Fertilization with RIKA-S did not improve the biomass production compared to the control.

Hence, fertilization with arGrow® Complete results in the highest biomass production among the tested conditions and is the only fertilizer that increased the soybean shoot biomass, compared to the control.

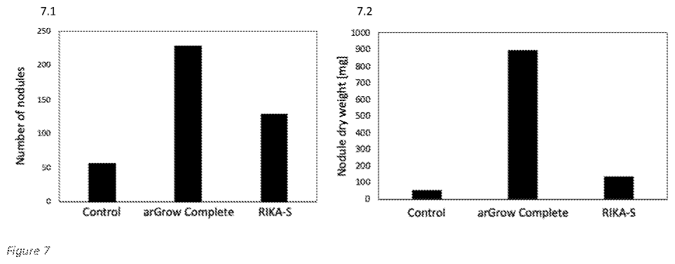

FIG. 7 illustrates the number and dry weight of soybean root nodules of plants that were grown in a low N potting substrate, “Såjord” (Hasselfors Garden), for 90 days in greenhouse conditions. All seeds have been inoculated with rhizobia. The presented control plants were not fertilized. Other plants were either fertilized with 30 kg N/ha arGrow® Complete or RIKA-S, as indicated, at a vegetative growth stage.

Fertilization of soybean plants increased the number of root nodules compared to the control (FIG. 7.1). Treatment with arGrow® Complete led to 229 nodules per root, whereas treatment with RIKA-S led to 129 nodules per root. Also, the nodule dry weight was considerably increased after fertilization with arGrow® Complete (FIG. 7.2).

It can be concluded, that arGrow® Complete displays to be the best fertilizer with respect to nodule development, as arGrow® Complete led to a 4× higher number of root nodules and a 16× higher nodule dry weight compared to control conditions.

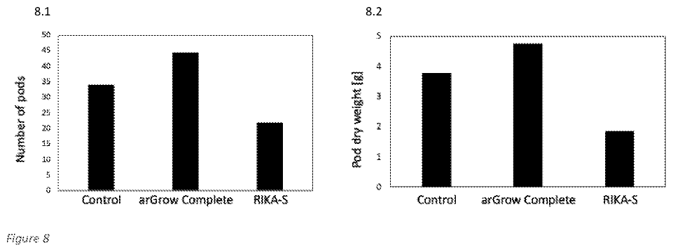

FIG. 8 illustrates the number and dry weight of soybean pods from plants that were grown in a low N potting substrate, “Såjord” (Hasselfors Garden), for 105 days in greenhouse conditions. All seeds have been inoculated with rhizobia. The presented control plants were not fertilized. Other plants were either fertilized at planting with 30 kg N/ha arGrow® Complete or RIKA-S, as indicated.

Fertilization of soybean plants increased the number of pods only when fertilized with arGrow® Complete (FIG. 8.1). This treatment led to 45 pods per plant, whereas treatment with RIKA-S led to 22 pods. Also the pod dry weight was only considerably increased after fertilization with arGrow® Complete (FIG. 8.2).

It can be concluded that arGrow® Complete displayed to be the best fertilizer with respect to plant yield, as arGrow® Complete led to a 1.3× higher number and dry weight of soybean pods compared to control conditions.

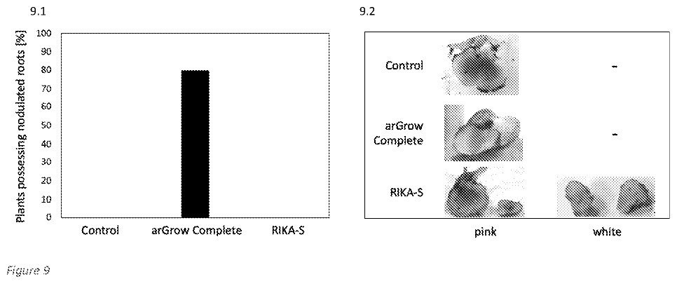

FIG. 9.1 illustrates the percentage of field bean plants, which displayed nodulated roots. Plants were grown in sand for 20 days in greenhouse conditions. All seeds have been inoculated with rhizobia. The presented control plants were not fertilized. Other plants were either fertilized at planting with 30 kg N/ha arGrow® Complete or RIKA-S, as indicated. Non of the control- nor the RIKA-S-treated plants exhibited any root nodules at that early plant developmental stage. Only treatment with arGrow® Complete led to nodule establishment at 80% of the plant's roots.

57 day old plants that were grown in the low N potting substrate, “Såjord” (Hasselfors Garden), all displayed nodule establishment at that timepoint (FIG. 9.2). Dissecting the nodules revealed only pink nodule tissue in control plants as well as in arGrow® Complete-treated plants, but a mix between white and pink nodule tissue in RIKA-S-treated plants. The color of the nodule tissue (red means active, white means inactive) indicates the capability of the bacteria to actively fix dinitrogen from the air. Hence, only at RIKA-S-treatment a mix of active and non-active root nodules was observed.

Hence, it can be concluded that treatment with arGrow® Complete positively influences nodule formation by promoting their establishment at an earlier timepoint compared to the control. Besides, arGrow® Complete does not seem to have a negative effect on nodule activity, conversely to RIKA-S.

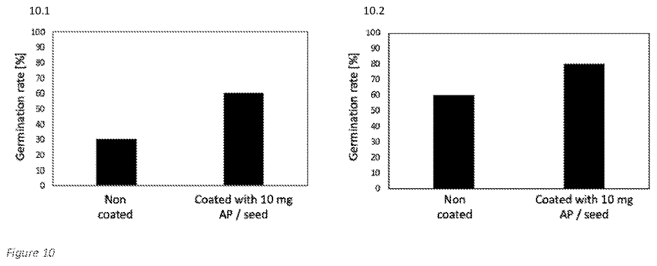

FIG. 10 displays results of a composition according to the invention. Soybean seeds were coated with 10 mg L-arginine phosphate and rhizobacteria. Germination of coated seeds was assessed in comparison to non-coated, but inoculated seeds. Seed germination after 6 days on filter paper (FIG. 10.1) or after 10 days in sand (FIG. 10.2) was assessed. I both cases the germination rate was increased when seeds were coated with L-arginine phosphate compared to the control.

In summary, a coating layer of L-arginine phosphate has a beneficial effect on soybean seed-germination.

### EXPERIMENTAL

The examples below are provided for illustrative purposes only and should not be construed as limiting the invention as defined by the appended claims. All references provided below or elsewhere in the present application are hereby included herein via reference.

### Example 1: Influence of Different Nitrogen Sources on Survival of Bacteria

The commercially available bacterial strains of Bacillus megaterium MVY-011 (isolated from BACTO-K, Bioenergy) and Bradyrhizobium japonicum (isolated from RhizoFix RF-10, Feldsaaten Freudenberger) were grown in 3 ml of sterile, liquid LB media (pH 7.0) overnight at 28° C. and 200 rpm. Growth of bacteria was checked by analyzing the optical density (OD₆₀₀) after overnight incubation. The bacterial cultures were adjusted to an OD₆₀₀ of 10⁻¹ with purified and sterile water. A dilution series to a final dilution of 10⁻⁶ was performed, resulting in a total of 6 dilution steps of the respective B. megaterium and B. japonicum cultures. Solid 15 ml LB agar plates were prepared under sterile conditions. Partially, different nitrogen (N) sources were added (Table 1). The positive control did not contain any added nitrogen source. All other agar plates were supplemented with different N sources (Table 1).

TABLE 1
Different nitrogen supplements were added into solid LB agar to
monitor growth of B. megaterium and B. japonicum.
Nitrogen treatments

| | | Nitrogen | |
|---|---|---|---|
| Supplements | Nitrogen form | content | Source |
| L-arginine | arginine monophosphate | 19.5% | Arevo AB |
| phosphate | | | |
| arGrow ® | arginine free base | 65 g/l | Arevo AB |
| Complete | | | |
| RIKA-S | ammonium nitrate | 84 g/l | Weibulls Horto |

The N supplements were added as sterile filtered solutions (pore size of 0.2 microns) to previously autoclaved LB agar under sterile conditions in a laminar flow. Different concentrations of the supplements were added to obtain a final molar concentration of 700 mmol N/l, 600 mmol N/l, 500 mmol N/l, 400 mmol N/l, 300 mmol N/l, 200 mmol N/l and 100 mmol N/l in the respective petri dishes.

5 μl of the bacterial dilutions were subsequently spotted on the agar with varying N concentrations by using a multichannel pipette under sterile conditions. After drying the plates, they were sealed and incubated at 28° C. Pictures of B. megaterium were taken after 24 hours. Pictures of B. japonicum were taken after 3 days.

### Example 2: Reduction of Toxic Effects of Nitrogen Towards Bacterial Growth Through Zeolites

The commercially available bacterial strains of Bacillus megaterium MVY-011 (isolated from BACTO-K, Bioenergy) and Bradyrhizobium japonicum (isolated from RhizoFix RF-10, Feldsaaten Freudenberger) were grown in 3 ml of sterile, liquid LB media (pH 7.0) overnight at 28° C. and 200 rpm. Growth of bacteria was checked by analyzing the optical density (OD₆₀₀) after overnight incubation. The bacterial cultures were adjusted to an OD₆₀₀ of 10⁻¹ with purified and sterile water. A dilution series to a final dilution of 10⁻⁶ was performed, resulting in a total of 6 dilution steps of the respective B. megaterium and B. japonicum cultures. Solid 15 ml LB agar plates were prepared under sterile conditions. Individually, different N sources were added (Table 1). The N supplements were added as sterile filtered solutions (pore size of 0.2 microns) to previously autoclaved LB agar under sterile conditions in a laminar flow. Different concentrations of the supplements were added to obtain a final molar concentration of 400 mmol N/l and 100 mmol N/l in the respective petri dishes. Some agar plates contained 200 mg of autoclaved, finely milled zeolites which were mixed in the agar solution upon preparation of the plates. 5 μl of the bacterial dilutions were subsequently spotted on the agar with varying N concentrations by using a multichannel pipette under sterile conditions. After drying the plates, they were sealed and incubated at 28° C. Pictures of B. megaterium were taken after 24 hours. Pictures of B. japonicum were taken after 3 days.

### Example 3: Addition of Succinic Acid Hinders Growth of Bacteria on Tested Nitrogen Sources

The commercially available bacterial strains of Bacillus megaterium MVY-011 (isolated from BACTO-K, Bioenergy) and Bradyrhizobium japonicum (isolated from RhizoFix RF-10, Feldsaaten Freudenberger) were grown in 3 ml of sterile, liquid LB media (pH 7.0) overnight at 28° C. and 200 rpm. Growth of bacteria was checked by analyzing the optical density (OD₆₀₀) after overnight incubation. The bacterial cultures were adjusted to an OD₆₀₀ of 10⁻¹ with purified and sterile water. A dilution series to a final dilution of 10⁻⁶ was performed, resulting in a total of 6 dilution steps of the respective B. megaterium and B. japonicum cultures.

Solid 15 ml LB agar plates were prepared under sterile conditions. Partially, different nitrogen (N) sources were added (Table 1).

The N supplements were added as sterile filtered solutions (pore size of 0.2 microns) to previously autoclaved LB agar under sterile conditions in a laminar flow. Different concentrations of the supplements were added to obtain a final molar concentration of 100 mmol N/l or 50 mmol N/l in the respective petri dishes. Partially, in water dissolved, sterile filtered (pore size of 0.2 microns) succinic acid (Sigma-Aldrich, 99.0%) was mixed into the agar solution to a final concentration of 7.4 mM, upon preparation of the plates.

5 μl of the bacterial dilutions were subsequently spotted on the agar with varying N concentrations by using a multichannel pipette under sterile conditions. After drying the plates, they were sealed and incubated at 28° C. Pictures of B. megaterium were taken after 24 hours. Pictures of B. japonicum were taken after 4 days.

### Example 4: Positive Influence of arGrow® Complete on Plant Biomass, Root Nodule Counts and Plant Yield

Soybean (variety Alexa, Skånefrö AB) were treated with RhizoFix RF-10 (Feldsaaten Freudenberger) according to the manufacturer's instructions to inoculate seeds. One soybean seed was then planted in a pot containing 3 litres of a low N potting substrate,

“Såjord” (Hasselfors Garden). As a top layer, vermiculite was added, and the initial watering of the pot was done with Nemablom (Bionema) as a one-time only treatment. Plants were grown in the greenhouse and watered daily for either 90 or 105 days, as indicated. Plants were once fertilized with different nitrogen sources, either by the addition of arGrow® Complete or RIKA-S (Table 2). Two different time points were chosen for the application of the fertilizer: at seed planting or at a vegetative growth stage of the soybean, 33 days after planting. Control plants were inoculated but not fertilized.

TABLE 2
Different nitrogen supplements were added to soybean pots
either at planting or a vegetative growth stage.
Nitrogen treatments

| | | | | Total |
|---|---|---|---|---|
| | | Nitrogen | | nitrogen |
| Supplements | Nitrogen form | content | Source | addition |
| arGrow ® | arginine free base | 65 g/l | Arevo AB | 30 kg N/ha |
| Complete | | | | |
| RIKA-S | ammonium nitrate | 84 g/l | Weibulls | 30 kg N/ha |
| | | | Horto | |

Different measurements were conducted after plants had been harvested. Plant above-ground tissue, excluding the pods, was harvested after 105 days and dried at 50° C. for two weeks. Afterwards the weight of the dried plant material was noted. Presented data originate from plants that were fertilized at planting stage.

In order to assess the number and dry weight of root-associated nodules, plant roots were washed in water and hence cleaned from the soil after 90 days. Nodules along the entire roots were counted and subsequently cut from the root. Collected nodules were dried at 50° C. for 2 weeks and then weighed. Presented data originate from plants that were fertilized at the vegetative stage.

The number of emerged pods was counted on day 105 after planting. Afterwards, pods were harvested, dried at 50° C. for 2 weeks and then weighed. Presented data originate from plants that were fertilized at planting.

### Example 5: Positive Influence of arGrow® Complete on Nodule Establishment and Activity

Field beans (Vicia faba, variety Boxer, Lantmännen) were treated with RhizoFix RF-20 (Feldsaaten Freudenberger) according to the manufacturer's instructions to inoculate the seeds. Five field bean seeds were planted in a pot containing 3 litres of sand and were fertilized with different nitrogen sources at planting (Table 2). Control plants have been inoculated but not fertilized. After 20 days, the number of plants displaying nodules along the roots were counted.

Field beans that have not been inoculated but fertilized according to Table 2 at planting were grown in parallel. 2 seeds were added in one pot, containing 3 litres of a low N potting substrate, “Såjord” (Hasselfors Garden). Control plants were not fertilized. Roots were investigated after 57 days and established nodules were dissected with a razor blade. The color of the nodule tissue (red means active, white means inactive) indicates the capability of the bacteria to actively fix dinitrogen from the air. Chosen pictures are representative pictures and do not display a quantitative measure.

### Example 6: Preparation of a Composition According to the Invention

Soybean (variety Alexa, Skånefrö AB) seeds were coated batchwise using a Concept ML2000 Coating machine (Satec) with a Sp quick Pumpdrive 5206 (Heidolph) pump connected for binder distribution. Fine powder of L-arginine phosphate (Table 1) was weighed to amounts corresponding to 10 mg L-arginine phosphate powder per soybean seed. In addition, 1% Carboxymethyl Cellulose (CMC, AkucellAF 1505 LV, Nouryon) was added as binder. As liquid for the coating process, RhizoFix RF-10 (Feldsaaten Freudenberger) was used.

CMC powder was mixed thoroughly with the L-arginine phosphate powder. The seeds were then put into the coating machine and liquid added until the seeds became wet. The powder mixture was added to the seeds until they were no longer tacky. More liquid was then added until the seeds became tacky once again. This cycle was repeated until all powder was bound to the seeds. A final spray of liquid was added after the last powder had been added. Control seeds were not coated but inoculated according to the manufacturer's instructions with RhizoFix RF-10 (Feldsaaten Freudenberger). Seeds were dried thoroughly and germinated on filter paper. After 6 days, the germination rate of 10 seeds in total was calculated. In parallel, 20 seeds were planted in sand and grown in the greenhouse. After 10 days the germination rate was assessed.

1. A composition comprising at least one macro nutrient and at least one microbe, which macro nutrient includes nitrogen in the form of a basic L-amino acid in association with phosphorus.

2. A composition according to claim 1, which is a liquid seed coating composition.

3. A composition according to claim 1, which is a slow release composition.

4. A composition according to claim 1, wherein said at least one microbe is a selected microbe, such as a nitrogen-fixing bacterium.

5. A composition according to claim 1, wherein said at least one microbe is present in the form of spores.

6. A composition according to claim 1, wherein said at least one microbe is present in an inoculum, preferably within a carrier such as a polymer or other supporting structure.

7. A composition according to claim 1, wherein the basic L-amino acid is arginine or lysine.

8. A composition according to claim 1, wherein the basic L-amino acid is associated with phosphorus via electrostatic interaction.

9. A composition according to claim 8, wherein the basic L-amino acid associated with phosphorus is arginine phosphate, such as arginine monophosphate and/or arginine polyphosphate.

10. A composition according to claim 8, wherein the basic L-amino acid associated with phosphorus is phosphoarginine.

11. A composition according to claim 1, wherein the basic L-amino acid associated with phosphorus is present in admixture with a microporous aluminosilicate mineral, such as a zeolite.

12. A seed treated with at least one selected microbe, a macro nutrient comprising nitrogen in the form of a basic L-amino acid and phosphorus.

13. A seed according to claim 12, wherein the treatment comprises application to the seed of at least one layer of selected microbe(s), at least one layer of said nitrogen in the form of a basic L-amino acid and at least one layer comprising phosphorus, optionally with intermediate layers in between.

14. A seed according to claim 12, which has been treated, e.g. coated, with a composition comprising at least one macro nutrient and at least one microbe, which macro nutrient includes nitrogen in the form of a basic L-amino acid in association with phosphorus.

15. A seed according claim 12, which comprises at least one layer of said at least one microbe and at least one layer of said nitrogen in the form of a basic L-amino acid in association with phosphorus.

16. A seed according to claim 12, wherein the treatment includes soaking the seed with an aqueous solution of said at least one microbe and application of basic L-amino acid and phosphorus in one or more layers.

17. A seed according to claim 16, wherein the nitrogen in the form of a basic L-amino acid is applied in a layer separate from a layer comprising phosphorus.

18. A seed according to claim 16, wherein the nitrogen in the form of a basic L-amino acid is associated with phosphorus in one or more layers.

19. A seed according to claim 12, wherein the basic L-amino acid associated with phosphorus is arginine phosphate and/or phosphoarginine.

20. A method for treating a seed with a liquid composition, which method comprises the steps of
a) providing at least one microbe, such as a selected microbe;
b) providing a macro nutrient including nitrogen in the form of a basic L-amino acid;
c) applying said at least one microbe and the macro nutrient to at least one seed.

21. A method according to claim 20, wherein step c) includes combining said at least one microbe and the macro nutrient with a binder to provide a liquid composition which is applied to said at least one seed.

22. A method according to claim 21, wherein the step of combining the microbe with the binder comprises granulation.

23. A method according to claim 20, wherein said at least one microbe is a nitrogen-fixing bacterium.

24. A method according to claim 20, wherein the basic L-amino acid is arginine or lysine.

25. A method according to claim 20, wherein the macro nutrient further comprises phosphorus.

26. A method according to claim 25, wherein the basic L-amino acid is associated with phosphorus, such as via electrostatic interaction.

27. A method according to claim 26, wherein the basic L-amino acid associated with phosphorus is arginine phosphate, such as arginine monophosphate and/or arginine polyphosphate; and/or phosphoarginine.

28. A method according to claim 20, which comprises a step of treating the seed with phosphorus.

29. A method according to claim 28, which method includes at least one cycle of applying a liquid comprising macro nutrient; applying a liquid comprising phosphorus; and drying the seed in between said applications.

30. A method according to claim 29, wherein said at least one microbe is applied to the seed before the macro nutrient and the phosphorus, such as by soaking the seed with an aqueous solution comprising the microbe.

31. A method according to claim 30, wherein said at least one microbe, the macro nutrient and the phosphorus are mixed as a liquid solution before the application thereof to a seed.
